(19) United States
(12) Patent Application Publication
(10) Pub. No.: US 2005/0221118 A1
(43) Pub. Date: Oct. 6, 2005

(54) Electroluminescent device

(75) Inventors: Klemens Brunner, Eindhoven (NL); Johannes Hofstraat, Eindhoven (NL); Luisa De Cola, Amsterdam (NL); Steve Welter, Haarlem (NL); Edward Allen Plummer, Amsterdam (NL)

Correspondence Address: PHILIPS INTELLECTUAL PROPERTY & STANDARDS, P.O. BOX 3001, BRIARCLIFF MANOR, NY, 10510, US

(73) Assignee: Koinklijke Philips Electronics N.V., BA Eindhoven (NL)

(21) Appl. No.: 10/515,747

(22) PCT Filed: May 28, 2003
(86) PCT No.: PCT/IB03/02052

§ 371 Date: Nov. 24, 2004

(30) Foreign Application Priority Data
May 31, 2002 (EP) 02077235.6
Jun. 5, 2002 (EP) 02077201.8

(51) Int. Cl. H05B 33/14

(52) U.S. Cl. 428/690; 428/917; 313/504; 257/40; 257/102; 257/103

(57) ABSTRACT

An electroluminescent device includes a first electrode, a second electrode and, dispersed therebetween, an electroluminescent layer comprising a first and a second electroluminescent compound capable of emitting light of a first and a second color respectively, the first color being different form the second color. The electroluminescent device is capable of reversibly emitting light having predominantly the first color when biased at a low voltage in a first direction and light having predominantly the second color when biased at a low voltage in a second direction opposite to the first direction. The first electroluminescent compound may be an electroluminescent polymer or low-molecular weight conjugated electroluminescent compound. The second electroluminescent compound is a metal-ion complex, typically mono-kernel or bi-kernel, having one or more ligands. At least one of said one or more ligands is substituted with a conjugated moiety, such as an oligo-phenylenevinylene or an oligo-phenylene derivative. The metal-ion complex is an ionic compound and has counter ions for balancing the charges of the metal ion which are capable of migrating within the electroluminescent device when the electroluminescent device is biased.

The invention relates to an electroluminescent (EL) device. In particular the invention relates to an EL device which is capable of emitting light of one color when biased in one direction and light of another color, different from the one color, when biased in another direction opposite the one direction.

Electroluminescent devices are devices which emit light when a suitable voltage is impressed on its electrodes. Electroluminescent devices can be used in applications like displays, lighting and signage. Organic electroluminescent devices include organic material to facilitate light emission. Organic electroluminescent devices are particularly suitable for applications which require a large light-emissive surface. A well-known variety of organic EL device is the organic light emitting diode (oLED). Being a diode, an oLED passes a substantial current only in one direction referred to as forward bias. In the opposite direction, also referred to as reverse bias, essentially no current flows.

In the international application WO 98/41065 a color-variable light emitting, more particular electroluminescent, device is disclosed which is capable of generating two independent colors. One color is generated in forward bias, another in reverse bias. The EL device include a single layer formed of a blend of polymers to facilitate color-variable light emission. Having the capability to generate two independent colors by variation of the direction of bias is of advantage in multi-color devices. Commonly, to obtain a multi-color device, independently addressable EL picture elements (also referred to as pixels) which emit different colors are positioned adjacent to one another. Having the capability of displaying multiple colors within one such picture element by variation of the direction of bias leads to a more compact device. Furthermore, such two-color devices are simpler to manufacture because, normally, each pixel having a distinct color requires a separate patterning step. For example, full-color devices require red, green and blue pixels to be provided by at least three distinct patterning steps.

A drawback of the color-variable device of WO 98/41065 is that relatively large voltages are required to obtain substantial light emission. To obtain 1 to 10 Cd/m² in either direction typically requires a bias of more than 10 Volts.

The object of the invention is, inter alia, to provide an new electroluminescent device which when biased in a first direction emits predominantly light of a first color and when biased in a second direction, opposite to the first, emits predominantly light of a second color, the second color being substantially different from the first color, and moreover does so at relatively low voltages in both directions, low being typically less than 10 V. Preferably, when biased at such low voltages the EL device is to light at a high brightness, high being typically more than 100 Cd/m² at 10 V.

These and other objects are achieved by an electroluminescent device including a first and a second electrode and an electroluminescent layer disposed therebetween, the electroluminescent layer comprising a first electroluminescent compound for emitting light of a first color, a second electroluminescent compound for emitting light of a second color which is distinct from the first color and a conjugated compound comprising a distinct conjugated moiety which is distinct from any other conjugated moiety the first and the second electroluminescent compound comprises,
wherein the conjugated compound comprising the conjugated moiety is the same as the second electroluminescent compound,
wherein the second electroluminescent compound is an ionic compound comprising ions adapted to be mobile within the electroluminescent layer when the electroluminescent is biased in the first and/or second direction to emit light of the first or second color respectively,
wherein the second electroluminescent compound is a metal-ion complex comprising a metal and at least one ligand which is substituted with the distinct conjugated moiety, the distinct conjugated moiety being selected to cause the color of light emitted in the first direction to be distinct from the color of light emitted in the second direction.

When the electroluminescent device in accordance with the invention is biased in the first direction, light emission predominantly originates from the first EL compound and thus the EL device emits predominantly light of the first color. When biased in the second direction, the second direction being opposite to the first, light emission originates predominantly from the second EL compound and thus the EL device emits predominantly light of the second color, the first and second color being substantially different. This effect is hereinafter also referred to as the “two-color effect”. Emitting predominantly light of the first (second) color means that emission from the first (second) EL compound dominates as in contributing more than 50%. In the remainder, when the EL device is said to emit light of the first (second) color includes the situation where light emission is predominantly of the first (second) color.

The two-color effect is obtained at relatively low voltages, on-set being typically less than about 10 V or even about 5 V. At 10 V, brightness significantly higher than 100 Cd/m² can be obtained.

The two-color effect is reversible. Switching being the first and the second color can be repeated. The two-color effect may be achieved in a layer wherein the first and second electroluminescent compound are homogeneously distributed in the EL layer as opposed to a phase-separated EL having first EL compound rich domains and second EL compound rich domains. Also, in directions transverse to the EL layer the EL compounds are homogeneously distributed. Having a homogeneous layer as opposed to a phase-separated layer is advantageous because in general the morphology of a phase-separated layer and with it the performance of the device comprising such layer tends to change during operational lifetime.

The presence of a two-color effect implies that the EL device in accordance with the invention is asymmetric. In the present invention the two-color effect is even observed if the first and the second electrodes having substantial the same work function. This is surprising because in the art it is commonly held that having electrodes of different work function is the primary cause of asymmetry of an organic LED.

In Appl. Phys. Lett, 68 (19), p 2708-2710 (1996), Yang Yang et al have described an EL device capable of emitting two different colors under the control of voltage. Within the EL layer of the EL device two spatially separate emission zones are distinguishable. Applying a first bias results in emission form the first zone, whereas applying a second bias results in emission form the second zone.

In Nature 372, p 444-446 (1994), Berggren et al achieve two-color light emission as a function of the size and not the direction of applied voltage from an EL device having a phase-separated EL layer.

In accordance with the invention the second electroluminescent compound and the conjugated compound are one and the same compound and therefore these terms are used interchangeably.

In the context of the present invention, an electroluminescent compound is a compound which is capable of emitting light when a layer comprising such compound is sandwiched between suitable electrodes and is subjected to a suitable voltage. For the purpose of this invention it may also be a combination of a charge transporting compound and a luminescent compound which is adapted to receive charges from the charge transporting compound to effect light emission. In general, in order to be electroluminescent, such a compound is capable of accepting and/or transporting holes and/or electrons and emit light having a certain emission spectrum which is characteristic for the compound. In a more narrow sense, an electroluminescent compound accepts electrons and holes which may recombine to cause emission of a light photon. Even more specific, the electroluminescent compound may be capable of exhibiting electroluminescence without assistance of charge transporting and light emission compounds in which case the electroluminescent compound accepts and/or transports holes and electrons which may recombine to cause light emission.

The first electroluminescent compound is an organic conjugated compound of low molecular weight or a conjugated polymer.

Organic conjugated compounds of low molecular weight known in the art as such may be used. Typically such compounds are C₁-C₁₀₀ homonucluear or heteronuclear aromatic compounds capable of forming thin films by means of evaporation in vacuo, examples include a coumarine, an aluminum quinolate or an acrinidine.

Alternatively, a conjugated polymer may be used. The conjugated polymer may be a cross-linked polymer, star polymer, dendrimer or a linear chain polymer. In the context of the invention the term polymer includes oligomer and copolymers, terpolymers and higher-order mers. The linear chain polymer may be a side-chain polymer having electroluminescent moieties as pendant side-groups or a conjugated polymer having EL structural units in the main chain. Examples of suitable electroluminescent polymers include those comprising a phenylenevinylene, a phenylene, a thiophene, a thienylvinylene, a fluorene or 9,9′-spirobifluorene structural unit or polymers like a polyphenylethylene, a polyquinoxaline, a polyvinylcarbazole, or copolymers thereof. Optionally such polymers are copolymerized with hole- or electron-transporting monomers such as triarylamines and oxadiazoles.

The charge transporting properties on the one hand and emission properties on the other hand may instead of being combined in a single electroluminescent compound (low molecular weight or polymer) also be distributed over separate compounds, for example a charge transporting compound and a luminescent compound. The luminescent compound may emit from the singlet state (singlet emitter) or from the triplet state (triplet emitter). Luminescent (both singlet and triplet) and charge transporting compounds are known in the art as such. Typically the charge trsporting compound is an EL compound. The luminescent compound is adapted to accept charges, holes and/or electrons, from the charge transporting compound. This is achieved, as is well known in the art, by suitably arranging the relevant energy levels relative to another. The highest occupied molecular orbital (HOMO) and oxidation potential is relevant for holes, the lowest unoccupied molecular orbital (LUMO) and reduction potential for electrons and their difference characterized by the absorption and emission spectra, to first order, for excitons.

The second electroluminescent compound is a metal-ion complex. In the context of the present invention, the terms “metal complex” and metal-ion complex” are used interchangeably. The metal-ion complex has a metal-ion (also loosely referred to as “metal”) and one or more ligands which are chemically bonded to the metal-ion. The combination of the metal-ion and the one or more ligands has a net charge which is to be balanced by ions, counter-ions, rendering the second electroluminescent compound an ionic compound.

Metal-ion complexes of the type required in accordance with the invention are known in the art as such.

Suitable metals from the metal-ion of the complex may comprises include Ru, Rh, Re, Os, Zn, Cr, Pd, Pt, Ir, Cu, Al, Ga or a rare earth metal. More particular, suitable metal-ions include a metal-ion selected from the group of Ru(RII), Rh(I), Re(I), Os(II), Zn(II), Al(III), Cr(III), Pt(II), Pt(IV) Pd(II), Ir(III), Cu(I), Ga(III) Ru(II), Ir(III) and Cr(III) and a rare earth metal ion. Preferred are Ir-ions and Ru-ions.

Ligands which are suitable for bonding to the metal-ion are known per se. Such known ligands may be used in the metal-ion complex of the present invention. The metal-ion and the one more ligands are selected such that the color of the light emitted by it, that is the second color, is distinctly different from the color emitted by the first electroluminescent compound.

The ligand may be a monodentate, a bi-dentate or generally polydentate ligand. Macrocyclic, monocyclic or, optionally bridged, polycyclic ligands may also be used.

Preferred ligands are those in accordance with one of the following formula: 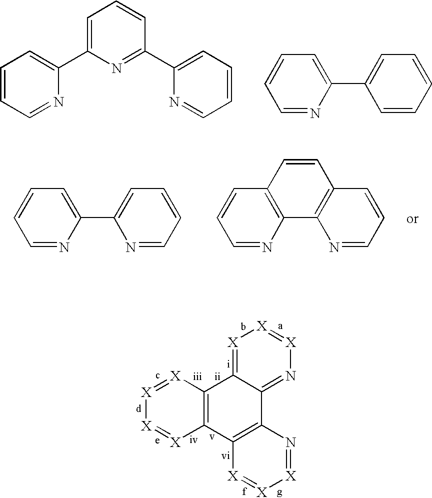
wherein X is independently CH or N, preferably at least one of the groups X being N, and the bonds a, b, c, d, e, f, and g, and the combination of bonds i/ii/iii and iv/v/vi are optionally condensed with a benzene group or a condensed aromatic moiety, wherein aromatic carbon atoms may be replaced by nitrogen, oxygen, phosphor or sulfur atoms and wherein a carbon atom of a ligand selected according to one of the above formula may be substituted with C₁₋₆ allyl, C₂₋₆ alkenyl, C₂₋₆ alkynyl, C₃₋₄ alkylene, CN, halogen, COOH, C₁₋₃ alkyl-COOH, NO₂, NH₂.

Macrocyclic ligands such as phthalocyanine and porphyrine ligands are also preferred.

To balance the charge of the combination of the metal-ion and the one or more ligands, the metal-ion complex has counter-ions. In accordance with the invention, said ions are adapted to be mobile within the electroluminescent layer when the electroluminescent device is biased in a first or second direction to emit light of the first or second color respectively. The presence of the ions allow the EL device to pass current in both the first (reverse bias) and the second (forward bias) direction. This effect is known in the art as such. Whether or not ionic movement occurs, is readily established by well-known time-dependent electrical measurements. Ionic movement occurs on distinct time and frequency scale. This time scale is milliseconds or larger, much slower than the time scale of electronic movement.

As is well known, size and ionic strength are properties of ions which can be used to adapt its mobility. Evidently, if the combination of metal-ion and ligand(s) has a net negative charge the counter ions must have a net positive charge to balance. Positive ions which typically have a suitable size and/or ionic strength and are moreover relatively chemically inert are metal-ions of the earth and alkali-earth metals or organic positive ions such as quaternized amines, ammonium being an example. More commonly, the net charge of the metal-ion ligand combination is positive, requiring the net charge of the ions to be negative. Suitable negative ions include the conjugate base of Bronsted acids such as halogen ions, nitrate, sulphate, carboxylates, and the like CN⁻ or conjugate bases of Lewis acids such as PF₆⁻, BF₄⁻, and AsF₆⁻.

The distinct conjugated moiety of the second electroluminescent compound is adapted to modify the charge (hole and/or electron) accepting, and/or donating and/or transporting properties of the material or layer of which it is part and consequently the electroluminescent properties of such a layer or material, where accepting and/or donating may refer to accepting or donating within the material or layer or to or from another material or layer. The distinct conjugated moiety is substituted to a ligand of the metal-ion complex. The distinct conjugated moiety forms with the conjugated system of the ligand a combined conjugated system having properties distinct from the separate conjugated systems.

The distinct conjugated moiety is distinct from other conjugated moieties. Distinct in the sense of having or introducing hole or electron or exciton states in the electroluminescent material which are not present in the corresponding electroluminescent material without the conjugated moiety. If it has or introduces such states the conjugated moiety is adapted to modify, or preferably to enhance, the charge (hole and/or electron) accepting and/or donating and/or transporting properties of the electroluminescent layer of which it is part.

Whether or not the distinct conjugated moiety is adapted to modify, or preferably to enhance, the charge (hole and/or electron) accepting and/or donating and/or transporting properties of the material or layer is easily established by dispersing an electroluminescent material or layer including such distinct conjugated moiety between suitable electrodes and make the device so obtained to electroluminesce and compare it with a device which has an electroluminescent material which does not comprise such distinct conjugated moiety but is otherwise identical. Any difference in the electro-optical performance such as IVL-characteristic, efficiency, lifetime is support that the distinct conjugated moiety is adapted to modify, or preferably to enhance, the charge (hole and/or electron) accepting and/or donating and/or transporting properties of the material or layer.

More specifically, the distinct conjugated moiety is adapted to modify the accepting and/or donating and/or transporting properties of the material or layer of which it is part in such a manner that when an electroluminescent device including a first and a second electrode and an electroluminescent layer disposed therebetween, the electroluminescent layer comprising a first electroluminescent compound for emitting light of a first color and a second electroluminescent compound for emitting light of a second color different from said first color, the second electroluminescent compound comprising the distinct conjugated moiety, is biased in a first direction the device emits light of a color which is the different from the color emitted when biased in a second direction opposite to the first. Whether or not so adapted is easily checked by comparing the device in accordance with the invention which a device which does not have the distinct conjugated moiety but is other is identical. Only in the case of the device in accordance with the invention should the two-color effect be observed.

A particular embodiment of the electroluminescent device is one wherein the distinct conjugated moiety is a univalent, bivalent or multivalent radical of a π-conjugated compound or a σ-conjugated compound with enhanced through bond interaction selected from the group consisting of alkenes, alkynes, aromatic compounds, arylalkenes, thiophenes, vinylthiophenes, fluorenes, anilines, vinylcarbazoles, phenylenethynes and pyrroles or oligomers of conjugated compounds selected from said group, C₅-C₁₀₀ fused aromatic hydrocarbons in which an aromatic carbon atom may or may not replaced with a nitrogen, a phosphor, sulfur or an oxygen atom, cyanines, squaryl or croconyl containing conjugated compounds, wherein each conjugated carbon atom of any such π-conjugated or σ-conjugated compound may or may not be substituted with a C₁-C₁₀₀ alkyl group, branched or unbranched, cyclic or acyclic, in which each non-neighboring carbon atom may be replaced with an oxygen, sulphur, nitrogen or phosphorus atom or substituted with a halogen, hydroxy, unsubstituted or alkyl substituted amino, nitrite, alkyl ether, branched or unbranched alkyl and/or alkenyl, nitro, trialkylphosphino, unsubstituted and substituted phenyl, carboxyl, carboxyl ester, carbamide or aryl, such as phenyl, group which aryl group is optionally substituted with an alkyl or an alkoxy group.

Preferred distinct conjugated moiety are radicals derived from benzene or naphthalene, radicals derived from arylalkenes, such as vinylbenzene in particular aryl substituted vinylbenzene, fluorenes such as bifluorenes, 9,9′-spirobifluorenes, and fused aromatic hydrocarbons such as perylenes and pyrenes.

Particularly preferred distinct conjugated moieties include radicals of oligo-phenylenevinylenes, oligo-phenylenes and oligo-fluorenes such as oligo-monofluorenes, oligo-bisfluorenes and spiro-bisfluorenes and other oligo-phenylenes wherein one or more neighboring phenylene groups by covalent bridges such —N—, —O—, —S—, or saturated bridges such C₂ or C₃ alkylene bridges in particular ladder-type oligo-phenylenes.

The metal-ion complex may a mono-kernel or a poly-kernel, in particular a bi-kernel, metal-ion complex.

A particular embodiment of the electroluminescent device in accordance with the invention is one wherein the second electroluminescent compound is a metal-ion complex comprising a first and a second metal-ion and respective first and second ligand bonded thereto, where the first and second ligand, being substituted with the same distinct bivalent conjugated moiety, are joined to each other.

The two-color effect shown by such poly-kernel complexes is particularly pronounced. Typically, in the first direction only light form the first electroluminescent compound is observed whereas in the second direction pure light-emission form the second electroluminescent compound is observed. A preferred such poly-kernel complex is one wherein the metal-ion is Ru(II) or Ir(III), the ligand or ligands being bonded is a 2,2′-bipyridyl or a phenylpyridine and the distinct bivalent conjugated moiety is an oligo-phenylene, an oligo-fluorene, such as an oligo-bifluorene or an oligo-9,9′-spirobifluorene, or an oligo-phenylenevinylene.

Particularly preferred second electroluminescent compounds are the metal-ion complexes of claims 9 to 14.

The first and the second electroluminescent compound may obviously be one and the same compound. As is well established in the art this may be conveniently realized by liking together the first and the second electroluminescent compound by means of one or more covalent chemical bonds. More particular, linking may proceed via a distinct linking group. The linking group may be a conjugated system or, preferably, linking group comprising saturated atoms such as an C₁-C₁₀₀ alkylene group to keep the conjugated systems of the first and second electroluminescent compound distinct. Non-interaction of the conjugated systems may also be achieved by linking the electroluminescent compounds together such that one system is twisted with respect to the other.

The electroluminescent layer may contain further substances such as hole-transporting, electron-transporting, hole-trapping, electron-trapping or exciton-trapping compounds. Compounds which enhance or block charge injection from layers adjacent to the EL layer may also be used. Compounds known in the art as such for this purpose may be used.

The EL layer is typically 10 to 70 nm thick if the EL layer is an organic layer of low molecular weight compounds and 30 to 300 nm thick if formed by means of a wet deposition method. Low molecular weight material is conveniently deposited by evaporation in vacuo whereas polymeric compounds may be deposited by spin-coating or ink-jet printing or another coating or printing method.

Unlike conventional organic LEDs which require a low-work function and thus chemically highly reactive electrode material to obtain efficient electron injection, the first and second electrode of the EL devices of the present invention may be both formed of high-work function material to observe the two-color effect. Suitable electrode materials are conducting inorganic oxides (particularly preferred because they are optically transparent) such as indium tinoxide (ITO), zinc indiumoxide, gallium indiumoxide, gallium indiumoxide or conducting polymers like polyethylendioxythiophene and polyaniline and metals such as Au, Al or Ag or any other conductive thin metal film. A preferred combination of electrodes is ITO and gold and ITO and Al.

The electroluminescent device may comprise further layers, electroluminescent devices comprising such further layers being known in the art as such. Known examples include hole-transporting, hole-injecting, electron-injecting, electron-transport, hole-blocking, electron-blocking and exciton-blocking layers.

Having the capability of showing multiple colors the electroluminescent device is particularly suitable for lighting applications, such as decorative lighting and signage and advertising, and display applications, such as segmented and matrix display devices, both passive and matrix. Since the EL devices in accordance with the invention can be manufactured readily in any size, the electroluminescent devices in accordance with the invention may be used practically any display size including television.

These and other aspects of the invention will be apparent from and elucidated with reference to the drawings and the embodiments described hereinafter.

In the drawings:

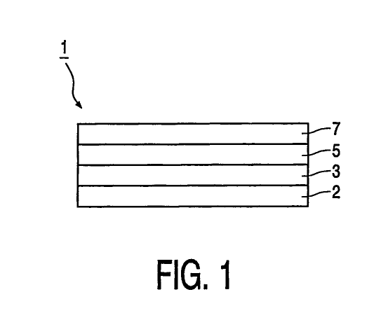

FIG. 1 shows, schematically, in a cross-sectional view an electroluminescent device;

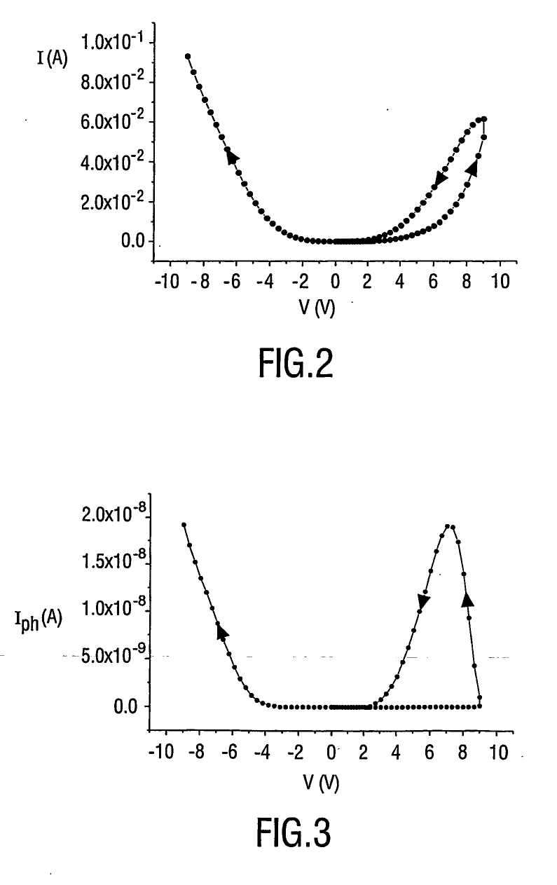

FIG. 2 shows a graph of the current I (in A) passing through an EL device in accordance with the invention as a function of applied bias V (in V) for a voltage sweep from 0 V to +10 V and back to −10 V;

FIG. 3 shows a graph of the photo-current Iₚₕ (in A) as a function of applied bias (in V) generated by the current shown in FIG. 2;

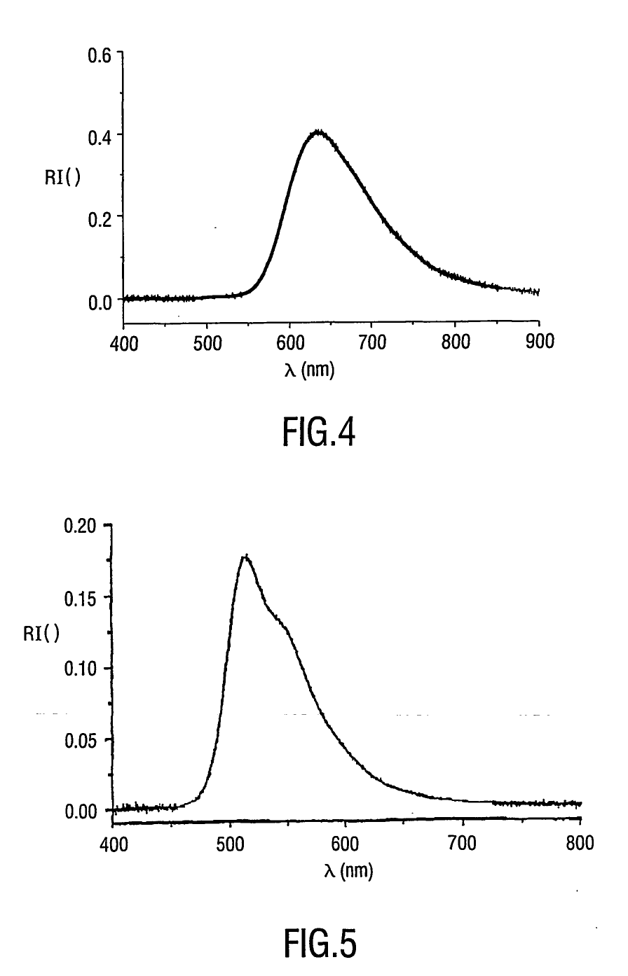

FIG. 4 shows an emission spectrum, relative irradiance RI (in dimensionless units) versus wavelength λ (in nm), at forward bias of the EL device of FIG. 2.

FIG. 5 shows an emission spectrum, relative irradiance RI (in dimensionless units) versus wavelength λ (in nm), at reverse bias of the EL device of FIG. 2.

### EXAMPLE 1

### Synthesis of (bis-2,2′-bipyridine)(para-4-bromophenyl-2,2′-bipyridyl)Ruthenium(II) bishexafluorophosphate [bpy₂RubpyPhBr][PF₆]₂ 3

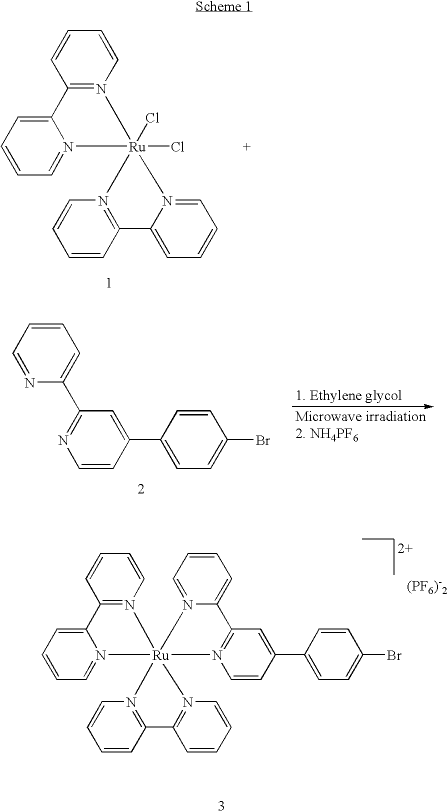 [0056] 1: cis-(bis-2,2′-bipyridine)ruthenium-bis-chloride
2: 4-bromophenyl-2,2′-bipyridine
3: (bis-2,2′-bipyridine)para-4-bromophenyl-2,2′-bipyridyl)Ruthenium(II) bishexafluorophosphate

The synthesis of [bpy₂RubpyPhBr][PF₆]₂ 3 is performed following scheme 1. Commercially available Ru(bpy)₂Cl₂ 1 (110.7 mg, 0.21 mmol) and the ligand 4-bromophenyl-2,2′dipyridyl (50.6 mg, 0.16 mmol) 2 (prepared according to a literature method of M. Montalti, S. Wadhwa, W. Y. Kim, R. A. Kipp, R. H. Schmehl Inorg. Chem. 39, p76-84 (2000)) are mixed in about 5 ml ethylene glycol. The mixture is placed in a modified microwave oven and irradiated at 450 Watt for 3 minutes and, after a cooling down period, for another 2 minutes. The stage of conversion is checked by TLC (Silica, eluent: NaCl (1): H₂O (10): CH₃CN (40): MeOH (10)), and longer irradiated if necessary. This procedure can be repeated several times (as larger amount of starting material in one experiment is not desired), and all fractions can be added together using e.g. acetone. Subsequently, the ethylene glycol (+ acetone) is distilled off under vacuum using a ‘micro distillation head’ at high temperature (90-110° C.). To the (almost) dry residue, water is added (±20 ml) and the water phase is extracted with chloroform several times to remove the excess of bpy₂RuCl₂. Any remaining chloroform in the water-layer is evaporated using a rotavap. Subsequently, 1 g of NH₄PF₆ in 2 ml water is added to the water-layer upon which an orange-red precipitate is formed. The precipitate is filtered off over kieselguhr (hyflo) and washed several times with water. Finally the compound so obtained is washed off from kieselguhr with acetone. The compound is then purified by column chromatography (aluminum oxide for chromatography type 705C neutral) using acetone as an eluent. For total isolation of the product, the column is eluted with acetone containing increasing amounts of water (1, 2, 3%). Metal-ion complex 3 yields as an orange powder in about 81% (dried under vacuum at 80° C.).

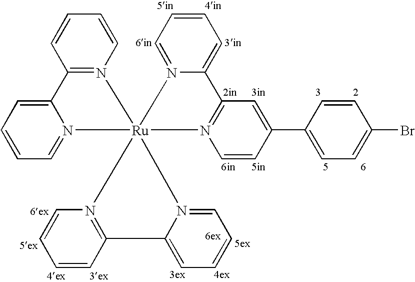

3: ¹H NMR (300 MHz, CD₃CN): δ=8.71 (s, 1H; 3ᵢₙ), 8.68 (d, ³J=8.0 Hz, 1H; 6ᵢₙ), 8.52 (dd, ³J=8.3 Hz, ⁴J=2.0 Hz, 4H; 3ₑₓ, 3′ₑₓ), 8.06 (m, 5H; 4ₑₓ, 4′ₑₓ, 4′ᵢₙ), 7.82-7.70 (m, 10H; 5ₑₓ, 5′ₑₓ, 5ᵢₙ, 5′ᵢₙ, 2, 3, 5, 6), 7.62 (dd, ³J=6 Hz, ⁴J=1.8 Hz, 1H; 3′ᵢₙ), 7.41 (m, 5H; 6ₑₓ, 6′ₑₓ, 6′ᵢₙ).

MS (ESI, m/z): 869.02 (M⁺-PF₆), 363.03 (M⁺-2PF₆).

### EXAMPLE 2a

### Synthesis of Ruthenium(4+), tetrakis(2,2′-bipyridine-κN1, κN1′)[μ-[4,4″″-(4, 1′:4′,1″:4″,1′″-quaterphenylene)bis[2,2′-bipyridine-κN1, κN1′]]di-, tetrakis[hexafluorophosphate(1-)](=[bpy₂Rubpy-ph₄-bpyRubpy₂][PF₆]₄) 7

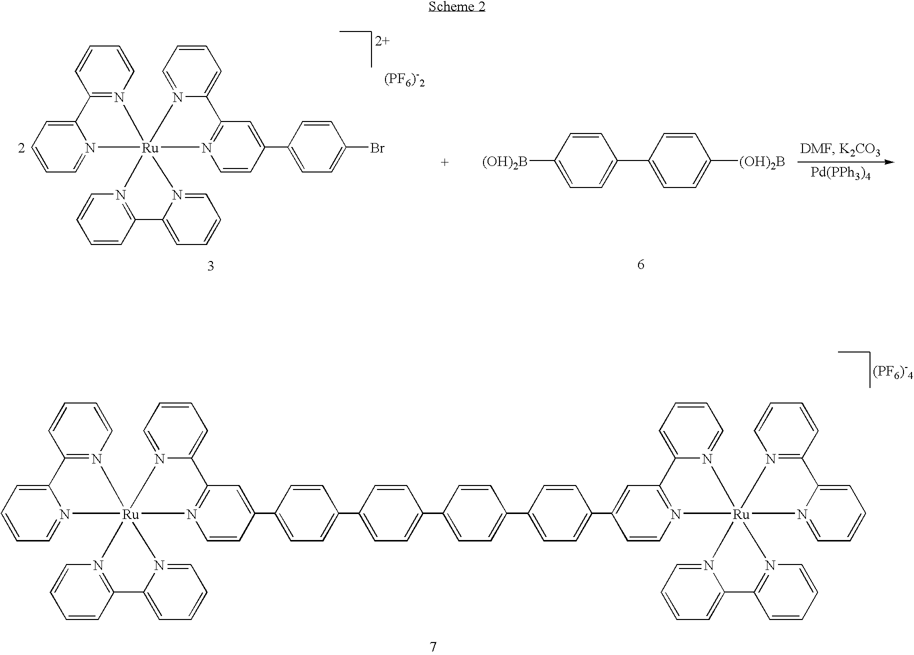 [0063] 6: 4,4′-biphenyl diboronic acid
7: Ruthenium(4+), tetrakis(2,2′-bipyridine-κN1, κN1′)[μ-[4,4″″-(4,1′:4′,1″:4″,1′″-quaterphenylene)bis[2,2′-bipyridine-κN1, κN1′]]]di-, tetrakis[hexafluorophosphate(1-)]

The synthesis of [bpy₂Rubpy-ph₄-bpyRubpy₂][PF₆]₄ 7 is performed following scheme 2. A solution of 3 (310 mg, 0.30 mmol), 6 (37 mg, 0.15 mmol) and Na₂CO₃⁻10H₂O (127 mg, 0.92 mmol) in DMF (10 ml)) is degassed (a cycles pump-freeze-thaw). Subsequently, Pd(PPh₃)₄ (10 mg, 4.6*10-3 mmol, 15%) is added and the reaction mixture heated to 90° C. After 16 h, the solvent is removed in vacuo (100° C.) and the residue purified by preparative thick layer chromatography (eluent: NaCl (1): H₂O (10): CH₃CN (40): MeOH (10)). The desired band is scratched off from the glass plate and the silica containing the product is washed with water and diethyl ether over a fritte. The product is washed out from the silica with acetone. If not all the product can be recovered a little bit of ammonium hexafluorophosphate is added to the acetone. Subsequently all the solvents are evaporated. The red solid so obtained is put on Kieselguhr and washed with water and diethylether to remove the excess of NH₄PF₆. Finally the product is recovered from the Kieselguhr using acetone. Metal-ion complex 7 yields after evaporation of the solvents (80%) as an orange-red solid.

¹H NMR (300 MHz, CD₃CN) δ=8.81 (s, 2H), 8.73 (d, ³J=8.0 Hz, 2H), 8.54 (dd, ³J=8.3 Hz, ⁴J=2.0 Hz, 8H), 8.20-7.68 (br m, 40H) 7.52-7.40 (m, 10H).

MS (ESI, m/z): 866.16 (M⁺-2PF₆).

### EXAMPLE 2b

### Synthesis of [bpy₂Rubpy-ph₄][PF₆]₂9

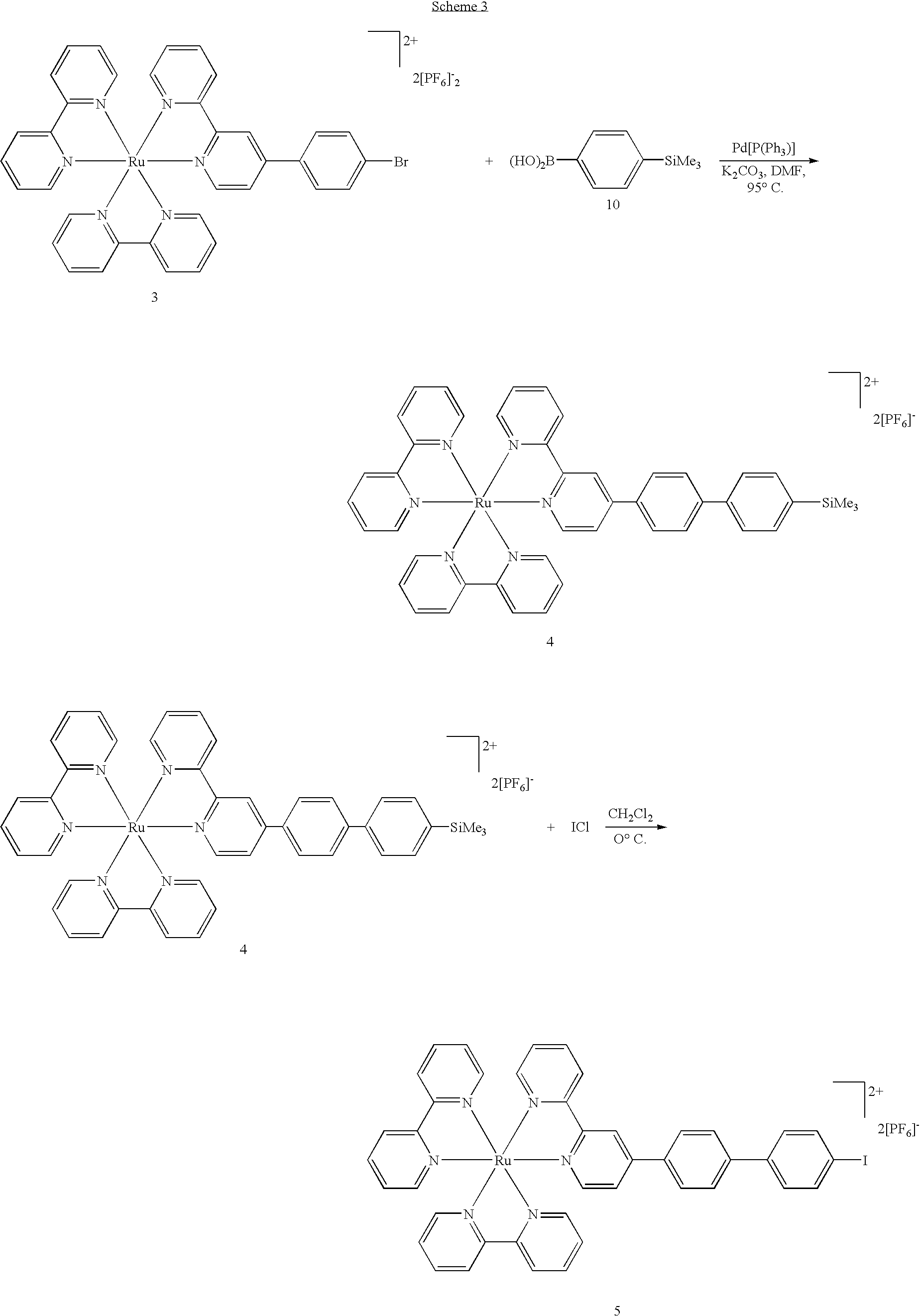

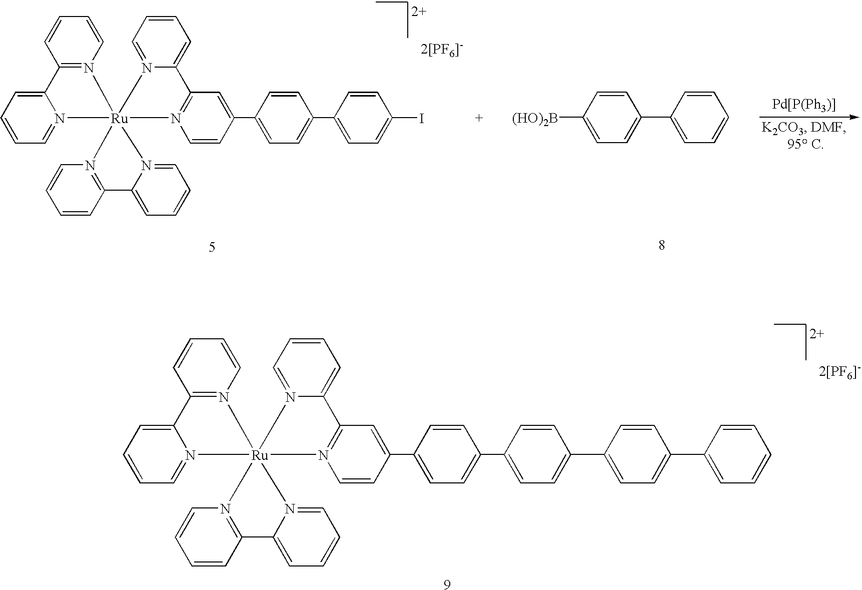

The synthesis of [bpy₂Rubpy-ph₄](PF₆)₂ 9 is performed following scheme 3. Compound 3 is subjected to a Suzuki cross-coupling reaction with 4trimethylsilane-phenyl-boronic acid 10 to obtain the Ru(bpy)₂(bis-bipyridine(4-trimethylsilane-biphenyl-bipyridine) 4. Substitution of trimethylsilane substituent with an iodine group using iodine chloride led to the halide functionalized compound 5 which is then used in a palladium(0) catalyzed cross-coupling reaction with biphenyl-4-boronic acid to obtain the desired (bpy)₂Rubpy-ph₄ 9. The compound is purified by chromatography using preparative thick layer chromatography (eluent: NaCl (1): H₂O (10): CH₃CN (40): MeOH (10)).

### EXAMPLE 3

### Synthesis of [(bpy)₂RubpyPPVbpyRu(bpy)₂][PF₆]₄ 14

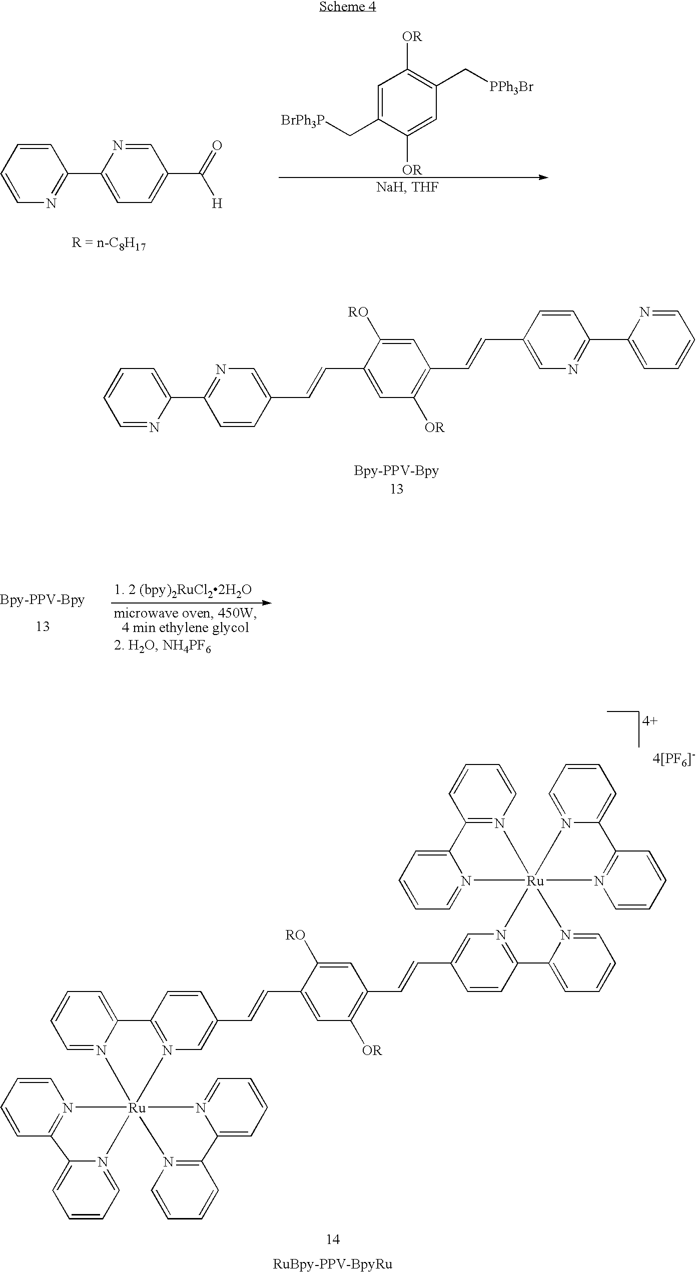

The synthesis of the compound [(bpy)₂RubpyPPVbpyRu(bpy)₂](PF₆)₄ 14 proceeds according to scheme 4. The ligand 13 was synthesized in another laboratory according to the scheme 4 and used as received. The bi-kernel ruthenium complex is made using the microwave oven procedure as previously described for the synthesis of metal-ion complex 7. The metal-ion complex 14 so obtained is isolated as an PF₆⁻ salt and purified by chromatography. The yield of this reaction is almost quantitative.

### EXAMPLE 4

### Synthesis of [bpy)₂Rubpy-Flu-bpyRu(bpy)₂][PF₆]₄ 18

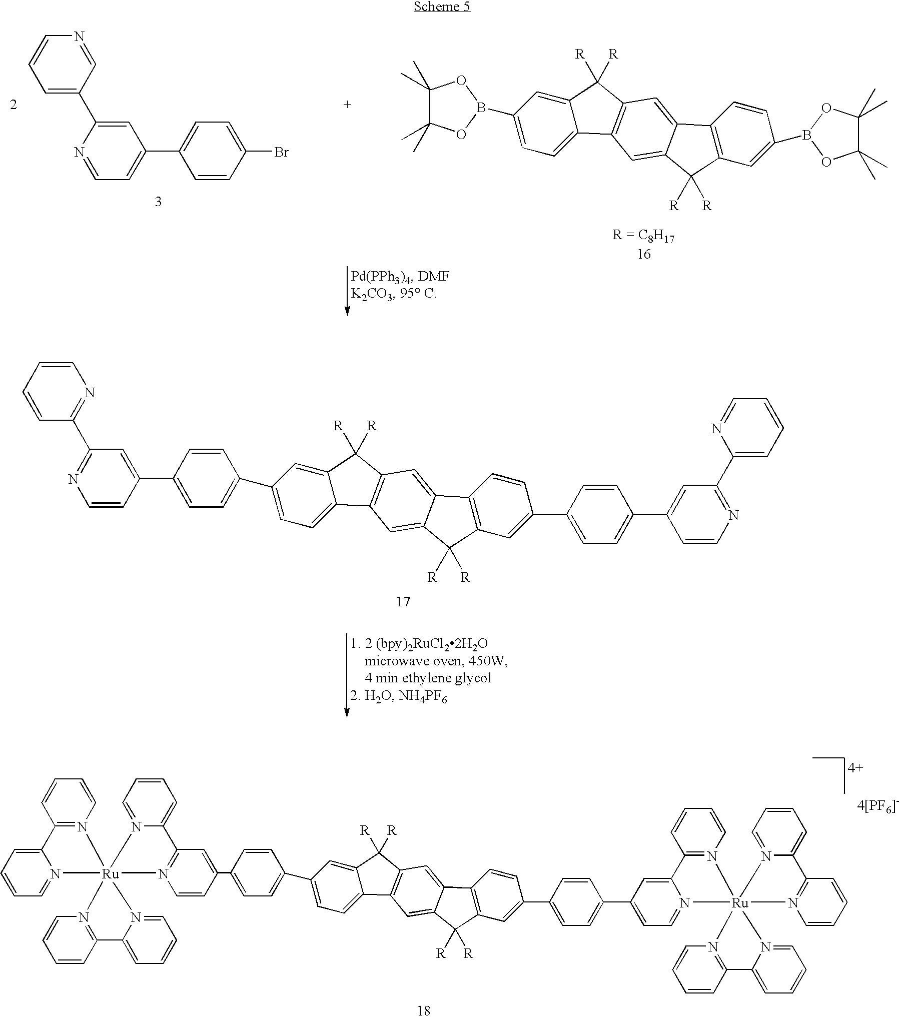

The complex (bpy)₂Rubpy-Flu-bpyRu(bpy)₂(PF₆)₄, 18 is synthesized according to scheme 5.

A. Synthesis of the ligand 17.

An excess of 4-bromo-phenyl 3 (49 mg, 15.7×10⁻⁵ mol) is reacted with tetraoctylindenofluorene bisboronate (50 mg, 5.22×10⁻⁵ mol) and a six-fold excess of potassium carbonate (43 mg, 3.1×10⁻⁴ mol) in 10 ml of dimethylformamide. After degassing using 3 cycles of pump-freeze-thaw the reacting mixture is put in an inert atmosphere (N₂). Then, palladium(0)tetrakis(triphenylphosphine) (6 mg, 5.2×10⁻⁶) is added and the reaction mixture is heated at 95° C. for 15 hours. After removing the solvent the crude product is washed with water and filtrated over celite. Washing with hexane and chloroform removes unreacted starting compounds. Further purification is obtained by re-crystallizing twice the yellow product from methanol. Tetraoctylindenofluorene bisbipyridine 17 yields as a white solid in 44% yield. The metal-ion complex [(bpy)₂Rubpy-Flu-bpyRu(bpy)₂][PF₆]₄ 18 is then prepared using the microwave method described above for metal-ion complex 7.

### EXAMPLE 5

### Synthesis of poly(2-(m-3,7-dimethyloctyloxy-phenyl)-p-phenylene-vinylene (green-PPV)

The green-emitting polymer poly(2-(m-3,7-dimethyloctyloxy-phenyl)p-phenylene-vinylene (green-PPV) is prepared according to the following procedure. In a dry three-neck flask a solution of 2,5-bis(chloromethyl)-1(m-3,7-dimethyloctyloxy-phenyl)benzene (15.03 g, 3.69 10⁻² mol) in 2 liters of dry dioxane (distilled) is degassed for 1 h by passing through a continuous stream of nitrogen and heated to 100° C. A base (24.76 gram, 0, 22 mol, 6 eq.) is added in two portions dissolved in dry and degassed dioxane (2 times 150 ml). The solution is heated for two hours at 100° C. A small amount (20 ml) of acetic acid is added to quench the base. The color changes from green to fluorescent green/yellow. The solution is then precipitated in water. After filtration the raw polymer is dissolved in THF by heating for 2 hours at 60° C. and precipitated in methanol. This procedure is repeated. The polymer is dried in vacuo and the yield is 8 grams of polymer (65%) in yellow fibers.

GPC: against polystyrene standards UV detection Mₙ=3.0 10⁵ g/mol Mw=1.5 10⁵ g/mol.

PL: λₘₐₓ=525 nm. ¹H-NMR (CDCl₃): δ(ppm)=7.9-6.8 (br. M, 9H), 4,2-3.9 (br. M, 2H) 2.0-1.0 (br, m., 13 H) 0.9 (s, 6H).

The yellow-PPV and copolymer of yellow-PPV and green-PPV is synthesized analogously.

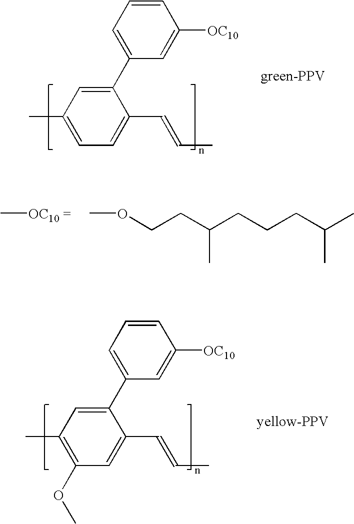

### EXAMPLE 6

### Not in Accordance with the Invention

### ITO/green-PPV+19.8 mM [Ru(bpy)₃][PF6]₂/Al

1. Device Structure and Manufacture

FIG. 1 shows schematically in a cross-sectional view an electroluminescent device. The two-color EL device 1 comprises a glass substrate 2, a first electrode 3, which in the present embodiment is a 120 nm transparent ITO layer, an electroluminescent layer 5 and a second electrode layer 7. The EL layer 5, in the present example 70 nm thick, comprises a first EL compound for emitting light of a first color, which in the present example is a green-emitting polymer poly(2-(m-3,7-dimethyloctyloxy-phenyl)-p-phenylene-vinylene (green-PPV) and a second EL compound for emitting light of a second color, the red light-emitting metal-ion complex [Ru(bpy)₃][PF6]₂. The second EL compound is an ionic compound having PF₆⁻ counter-ions. The metal ion is a Ru(II)-ion to which three 2′-2 bipyridine ligands are bonded. None of the ligands is substituted with a conjugated moiety. The electrode 7 is in this example a 100 nm thick layer of aluminum. The general structure of the device may be abbreviated as follows: ITO/green-PPV+[Ru(bpy)₃][PF6]₂/Al.

The EL device 1 may be manufactured as follows:

A glass plate 2 covered with a 120 nm layer of ITO is treated on the ITO-side for 10 min with UV/O₃ (UVP PR-100). A solution containing 3 mg/mi green-emitting polymer poly(2-(m-3,7-dimethyloctyloxy-phenyl)-p-phenylene-vinylene (green-PPV) and of 19.8 mM metal-ion complex Ru(bpy)₃(PF6)₂ is prepared by adding to a green-PPV dichloromethane solution stirred overnight at room temperature the appropriate amount of metal-ion complex from a stock solution of 2 mg metal-ion complex dispersed in 50 μL acetonitrile. The green-PPV/CH₂Cl₂/Ru-complex solution is further stirred at RT for 1 hour and filtered over a 5 μm PTFE filter (Millex, Millipore) prior to spin-coating. A 70 nm electroluminescent layer 5 is then obtained from the green-PPV/metal-ion complex solution by means of spin-coating (spin-coater form BLE Laboratory Equipment GmbH, 1200 r/min (10 ), followed by 300 r/min (25s)). The aluminum electrode layer 7 is then deposited in a vacuum chamber at a pressure of 8.0-9.0×10⁻⁶ Torr at a rate of 5 Å/s. The entire process of manufacture is carried out in a glove-box with oxygen and water content below 1 ppm.

2. Electro-Optical Characteristics

The electrical characteristics of the device manufactured under 1 are measured with an automated current-voltage-light (IVL) measuring unit (BP 2400 Source Meter, HP 6517A Electrometer) at room temperature. A photo-diode calibrated with a luminance meter (Minolta LS-110) is used to measure the light output of the device. Alternatively, a fibre can be used instead of the photo-diode and the electro-luminescence spectrum can be measured (Ocean Optics, S2000). Light emission is characterized by recording an emission spectrum at a fixed voltage by means of a glass fibre connected to the spectrometer. Measurements are taken in a glove-box with oxygen and water content below 1 ppm.

Within 2 hours after the evaporation of the electrodes, the device manufactured under section 1 above is subjected to a linear voltage sweep starting at 0 V and stopping at +10 V and then back to −10 V where “+” corresponds to a positive voltage on the ITO electrode layer 7, also referred to as forward bias, and “−” to a negative voltage on the ITO electrode, reverse bias.

When the bias exceeds a certain threshold, also referred to as the “onset”, a current passes through the device 1. In the present example, a current is established both in reverse and forward bias. A photo-current and thus light emission is however only observed in forward bias. The light emitted is a combination of red light originating from the metal-ion complex and green light from green-PPV polymer.

Clearly, this device is not two-color device in accordance with the invention as it does not emit light in a first direction of bias which is different form light emitted in an opposite second direction of bias.

### EXAMPLE 7

### Not in Accordance with the Invention

### ITO/green-PPV+0.79 mM [Ru(bpy)₃][PF6]₂/Al

Example 6 is repeated except that a much lower amount of metal-ion complex is added producing a 0.79 mM solution of metal-ion complex. During the 0 V/+10 V/−10 V voltage sweep, at positives voltage green light emission is observed. In reverse bias, no light emission is observed. Accordingly, the device is not a two-color in accordance with the invention.

### EXAMPLE 8

### In Accordance with the Invention

### ITO/green-PPV+[(bpy)₂Rubpy-ph₄][PF₆]₂ 9/Al

Example 6 is repeated, both manufacture and measurement, with the difference that in the present example the metal-ion complex used is [(bpy)₂Rubpy-ph₄][PF_{6]}₂ 9. In contrast to the complex of Example 6, metal-ion complex 9 has a ligand substituted with a distinct conjugated moiety, i.e. bpy-ph₄ the distinct conjugated moiety being the quarter-phenyl mono-valent radical ph₄. The concentration of the metal-ion complex in the solution from which the EL layer is spin-coated is relatively low, about 1.2 mM.

Devices doped with 1.2 mM [(bpy)₂Rubpy-ph₄][PF₆]₂ 9 pass a current both in forward and reverse bias. Predominant red light-emission from the ruthenium mono-kernel complex 9 is observed at forward bias and green emission from the polymer at reverse bias. Accordingly, the device is a two-color device.

If the concentration of metal-ion complex is lowered to about 0.79 mM a photocurrent is only obtained at forward bias. The emission spectra taken at forward bias show green and red light emission from polymer and ruthenium mono-kernel complex respectively. Most of the emission is coming from the polymer.

At high concentration (2.0*10⁻³M) a two-color effect is observed with pure red emission from the ruthenium metal-ion complex at forward bias and green light in reverse bias.

### EXAMPLE 9

### ITO/green-PPV+50 w % [bpy₂Rubpy-ph₄-bpyRubpy₂][PF₆]₄ 7/Al

Example 6 is repeated with the difference that the EL compound in this example is the bi-kernel ruthenium metal-ion complex [bpy₂Rubpy-ph₄-bpyRubpy₂][PF₆]₄ 7.

FIG. 2 shows a graph of the current I (in A) passing through an EL device in accordance with the invention as a function of applied bias V (in V) for a voltage sweep from 0 V to +10 V to −10 V.

As a function of applied bias, the current is nearly symmetrical around 0 V, with an onset of about 1 to 2 V (−1 to −2 V for the reverse bias). The exact onset voltage depends on the applied pre-stress voltage, if any, and voltage sweep rate. FIG. 2 shows hysteresis in forward bias, the lower curve corresponding to the sweep from 0 V to +10 V and the upper curve to the sweep from +10 V to 0 V. Hysteresis is thought to be due to ionic gradient not being developed during the first forward sweep. Pre-stressing the device helps to suppress the hysteresis.

FIG. 3 shows a graph of the photo-current Iₚₕ (in A) as a function of applied bias (in V) generated by the current shown in FIG. 2.

The photo-current, which is a measure of the amount of light emitted by the EL device, substantially follows the current of FIG. 2. The photo-current is nearly symmetric around 0 V if the forward bias return sweep is compared with the reverse bias sweep indicating (again) that the EL device in accordance with the invention is not a (light-emitting) diode. At 10 V, a brightness significantly higher than 100 Cd/m² is obtained.

FIG. 4 shows an emission spectrum, relative irradiance RI (in dimensionless units) versus wavelength λ (in nm), at forward bias of the EL device of FIG. 2. The emission spectrum is characteristic of the red light emitted by the bi-kernel Ru-complex.

FIG. 5 shows an emission spectrum, relative irradiance RI (in dimensionless units) versus wavelength λ (in nm), at reverse bias of the EL device of FIG. 2. The emission spectrum corresponds to that of the green PPV conjugated polymer.

Emitting red light in forward bias and green light in reverse, the EL device of the present example is a two-color device. The two-color effect is observed with two air-stable electrodes, viz. ITO and Al.

From Examples 6 through 9 it is clear that in order to observe a two-color effect in an EL device having an EL layer comprising a first EL compound, in particular a conjugated polymer, and a second EL compound in the form of a metal-ion complex it is necessary that at least one ligand of the metal-ion complex is substituted with a distinct conjugated moiety adapted to modify the charge-injection and/or charge-transporting and/or light emitting properties of the EL layer.

### EXAMPLE 10

### ITO/green-PPV+[bpy₂Rubpy-ph₄-bpyRubpy₂][PF₆]₄ 7/Al

To explore the properties of the EL device of Example 9 further another EL device comprising the metal-ion complex [bpy₂Rubpy-ph₄-bpyRubpy₂][PF₆]₄ 7 is manufactured.

To the device obtained a constant bias of +6.0 V is applied (time t=0 seconds) and the intensity of the light emitted by the device at 625 nm is measured as a function of time. It is observed that, in contrast to conventional oLEDs, light emission is not instantaneous. As time passes the intensity of light emission gradually increases monotonically concave up to t=140 seconds and decreases monotonically concave after that time to reach substantially zero intensity at about t=250 seconds.

The time scale on which changes in light emission intensity are observed indicates that ionic transport phenomena influence light emission in an essential manner.

### EXAMPLE 11

### ITO/green-PPV+[bpy₂Rubpy-ph₄-bpyRubpy₂][PF₆]₄ 7/Al

To explore the properties of the EL device of Example 9 further another EL device comprising the metal-ion complex [bpy₂Rubpy-ph₄-bpyRubpy₂][PF₆]₄ 7 is manufactured.

The EL device so obtained is first pre-stressed at a forward bias of +7 V for 1 min resulting in red emission from the ruthenium metal-ion complex, then a reverse bias of −6 V is applied. Upon reversal, light emission immediately ceases. Then, on a time scale of about 1 to 2 minutes green light emission gradually builds. Upon reversal of the bias to a forward bias +7 V green light emission immediately stops and in the course of about 1 to 2 minutes red light emission gradually grows in.

This example again points to involvement of ionic migration processes in light emission and further illustrates that the two-color effect is reversible. Unlike conventional light-emitting electro-chemical cells where migration of ions is also essential to achieve light emission, the two-color EL device of the present invention is intrinsically asymmetric in that red light emission is always produced in forward bias and green light in reverse bias. This is irrespective the cycling history of the device.

### EXAMPLE 12

### ITO/green-PPV+[bpy₂Rubpy-ph₄-bpyRubpy₂][PF₆]₄ 7/Au

This example is the same as Example 9 except that instead of aluminum cathode a gold cathode is used.

The EL device behaves similar to the device of Example 8; it emits red light in forward bias and green light in reverse.

### EXAMPLE 13

### Not in Accordance with the Invention

### ITO/Au/green-PPV+[bpy₂Rubpy-ph₄-bpyRubpy₂][PF₆]₄ 7/Au

A glass plate covered with ITO is treated on the ITO-side with UV/O₃ (UVP PR-100) for 10 min. A gold layer is then deposited on the ITO surface at a rate of 0.5 nm/s until a thickness of 20 nm is obtained. The gold layer is sufficiently thin to be transparent. An EL layer is then deposited onto the Au layer by spin-coating (1000 rpm, 10 s) a solution of 2.5 ml dichloromethane containing 7.5 mg green-PPV and 5 mg [bpy₂Rubpy-ph₄-bpyRubpy₂ ][PF₆]₄ 7 producing an EL layer having 1 part weight polymer and 0.4 parts by weight Ru-complex. To prevent degradation of the Au electrode, the electrode contacts are carefully cleaned with a cotton bud drenched in acetone. Onto the EL layer a second, 100 nm thick, Au electrode layer is then deposited at 0.25 nm/s.

The EL device so obtained is subjected to a forward bias resulting in red light emission from the Ru complex. Applying a reverse bias also results in red light emission. Thus, the EL device is not an EL device in accordance with the invention. Clearly, the EL device of this example is substantially symmetric. (Some difference reverse and forward current is observed due to the gold electrodes not being identical; gold electrodes provided on hard condensed matter (here ITO) behave differently from those deposited on soft condensed matter (here organic EL layer)).

Comparing the result of Examples 12 and 13 demonstrate that in order for the two-color effect to be observed the EL device must be asymmetric. In the examples above which are in accordance with the invention asymmetry is introduced by means of different electrodes.

### EXAMPLE 14

### ITO/green-PPV+[bpy₂Rubpy-PPV-bpyRubpy₂][PF₆]₄ 14/Al

Following the procedure of Example 9, an EL device is prepared which is identical to that of Example 9 with the exception that the ruthenium complex used is [bpy₂Rubpy-PPV-bpyRubpy₂][PF₆]₄ 14.

In the EL device so obtained, a current and photo-diode current is observed in forward and reverse bias. In forward bias the EL device emits red light, in reverse bias green light. The brightness of the green light emission is significantly lower than the emission obtained from the Example 9 device containing [bpy₂Rubpy-ph₄-bpyRubpy₂][PF₆]₄ 7.

### EXAMPLE 15

### Not in Accordance with the Invention

### ITO/green-PPV+[bpy₂Rubpy-Ada₂-bpyRubpy₂][PF₆]₄ 15/Al Following the procedure of Example 9, an EL device is prepared which is identical to that of Example 9 with the exception that the ruthenium complex used is [bpy2Rubpy-Ada₂-bpyRubpy2][PF₆]₄ 15. It is to be noted that the adamantane moiety Ada₂ is not conjugated moiety but a saturated moiety.

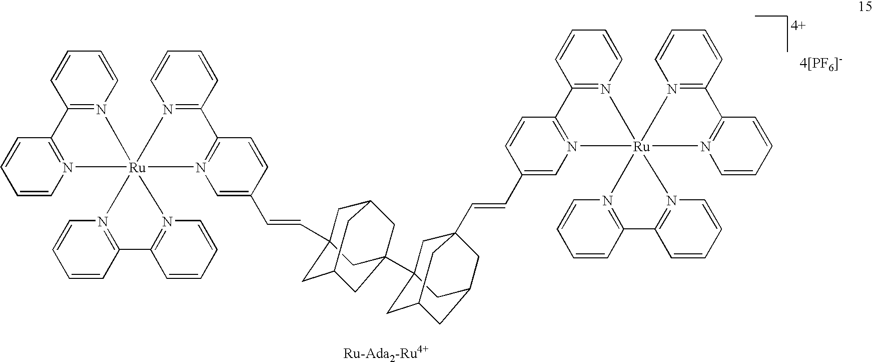

In the EL device so obtained, a current and photo-diode current is observed in forward bias. In reverse bias, however, a current is observed but no photo-diode current indicating that the EL device does not emit light in reverse bias. In forward bias the EL device emits both red and green light.

The results of Examples 9, 14 and 15 demonstrate that in order to observe a two-color effect the ruthenium complex must have a ligand substituted with a moiety which is conjugated.

### EXAMPLE 16

### Not in Accordance with the Invention

### ITO/green-PPV+Rubpy₂(CN)₂/Al

Following the procedure of Example 9, an EL device is prepared which is identical to that of Example 9 with the exception that the ruthenium complex of Example 9 is replaced with the Rubpy₂(CN)₂. In contrast to the ruthenium complex of Example 9, the complex Rubpy₂(CN)₂ is non-ionic compound. The cyanide groups co-ordinately bond to the metal-ion and thus cannot migrate in an electric field set up in the EL layer when a bias is applied.

The EL device thus obtained is subjected to a forward and reverse bias respectively, forward bias again corresponding to the ITO anode being at a positive voltage and the cathode negative.

In forward bias, a current and photo-current is observed be it that the onset for the current and photo-current is about +11 V which is significantly higher than observed for the charged ruthenium complex used in Example 9.

When performing a voltage sweep significantly less hysteresis is observed compared the EL device of Example 9, consistent with the fact that the complex of the present example does not have mobile ions. Varying the ratio of green-PPV to Ru complex affects the amount and color of light emitted but does not affect the onset of light emission. The light emitted in forward bias is not pure but a mixture of red and green. Increasing the amount of Ru complex relative to the polymer increases red light emission relative to green.

In reverse bias, the EL device does not pass any current and hence no photo-current is observed in the photo-diode. As in conventional EL devices at negative voltages close to break-down (here about −17 V) a faint light emission is observed. At such high voltages even the high work function ITO is capable of injecting electrons.

The present example demonstrates that in order to observe a two-color effect the presence of ions which can migrate within the EL device is essential.

### EXAMPLE 17

### Not in Accordance with the Invention

### ITO/green-PPV+11 w % bpy₂Rubpy-ph₄-bpyRubpy₂ (PF₆)₄ 7+72 w % N(C₄H₉)₄PF₆/Au

Following the procedure of Example 9, an EL device is prepared which is identical to that of Example 9 with the exception that the salt N(C₄H₉)₄PF₆ is added in an amount such the EL layer comprises for every 100 g of polymer 11 g of Ru-complex and 72 g of salt. Having 72 g salt to every 100 g of polymer corresponds to a 10-fold increase in the concentration mobile ions within the EL device compared to the EL device of Example 9 where no additional salt is added where it is assumed that the N(C₄H₉)₄⁺ ion is too large to be mobile, and thus all mobile ions are PF₆⁻ ions.

The EL device so obtained is subjected to a forward and a reverse bias respectively. In both forward and reverse bias, a current and a photo-current is observed. Light emission is very homogeneous. The color of the light emitted is in both cases red indicating emission from Ru complex. Green light emission is not observed. The two-color effect is not observed. The EL device shows behavior typical of an electrochemical cell. Observing similar behavior in reverse and forward bias in spite of the presence of different electrode materials is typical for light-emissive electrochemical cells. The effect of adding salt is to take out the difference in effect brought about by the difference in electrode materials. Clearly, in order to observe a two-color effect such symmetry is to be avoided.

### EXAMPLE 18

### ITO/green-PPV+[bpy₂Rubpy-ph₄-bpyRubpy₂][PF₆]₄ 7/Al

An EL device is manufactured using the method outlined in Example 9. The EL device so obtained is analyzed with secondary ion mass spectroscopy (SIMS). In particular, the concentration of Ruthenium in a direction at right angles to the EL layer is measured throughout the EL layer. The Ru concentration so measured was substantially throughout the EL layer, indicating that the Ru complex is distributed homogeneously (and accordingly the polymer since the EL layer comprises only these two components) within the layer.

A fresh identical EL device is prepared which is stressed in reverse and forward bias respectively for a certain period of time. Red light emission is observed in forward bias, green in reverse. The EL device so stressed is subjected to the SIMS measurement describe above. The measurement results show that the Ru complex is remains distributed homogenously in the EL layer.

This Example shows that the two-color effect observed in the present invention is not due to the presence of distinct recombination zones within the EL layer which each have a distinct color of light emission.

### EXAMPLE 19

### green-PPV+[bpy₂Rubpy-ph₄-bpyRubpy₂][PF₆]₄ 7

A film of green-PPV+ [bpy₂Rubpy-ph₄-bpyRubpy₂][PF₆]₄ 7 spin-coated on a suitable substrate is positioned in an atomic force microscope (AFM) equipped with a silicon tip. The surface of the EL layer is then mapped with the tip operated in tapping mode. Using the measurements, images of the surface reflecting differences in height reflecting differences in phase are constructed.

To facilitate interpretation of the images so obtained, the experiment is repeated with a film which is identical except that it only contains green-PPV polymer and no ruthenium complex.

Comparison of the surface images shows that the morphology of the pure polymer film is substantially identical to that of the polymer+Ru complex film. The differences visible in the images are attributable to differences in interaction between the tip and a Ru molecule and a polymer molecule respectively and do not reflect a real difference in height or a difference in phase.

The morphology being substantially the same shows that there is no large-scale phase separation in the polymer +Ru complex film which in turn proves that the two-color effect of the present invention is not caused by emission from different phase domains of a phase-separated film. Two-color effects based on phase-separated films are known in the art as such

On the contrary, if large-scale phase separation is deliberately introduced the two-color effect of the present invention disappears. For example, if in the EL device of Example 9 PF₆ ions are replaced by fluor ions, the resulting Ruthenium complex is poorly miscible with the green-PPV polymer resulting in an EL device having large-scale-separated EL layer which does not show any two-color effect.

### EXAMPLE 20

### Synthesis of [Ir(ppy)₂bpyPhBr][PF₆] IR3

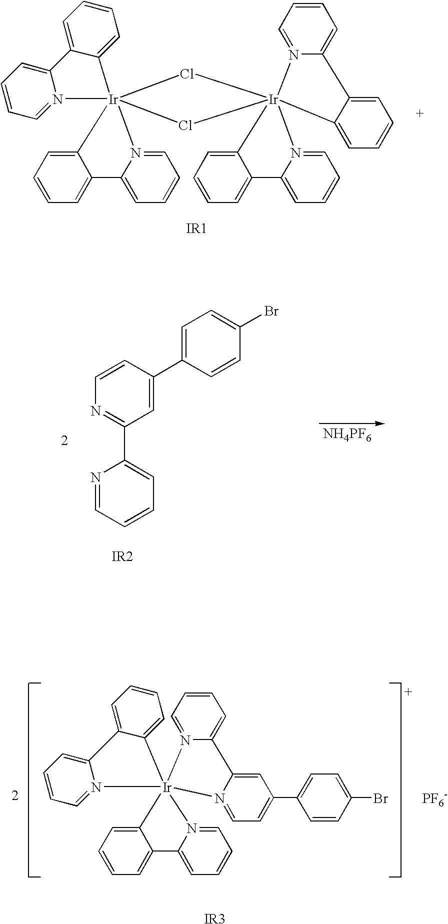

A quantity (0.13 g, 0.123 mmol) of the iridium compound IR1, synthesized in accordance with the procedure published by Spouse et al. in J. Am. Chem. Soc. 1984, 106, 6653-6659 and a quantity (0.06 g, 0.194 mmol) of bipyridyl derivative IR2 (=2 above) is dissolved in a dichloromethane/methanol (3:1, 20 cm³) and heated to reflux under a nitrogen atmosphere for 3 hours. The volume of the solution is reduced to 5 cm³ and methanol is added (10 cm³). An excess of saturated methanolic ammonium hexafluorophosphate is added. The resulting precipitate is filtered off and washed with water (20 cm³), methanol (20 cm³), and finally diethyl ether (20 cm³) to yield the metal-ion complex IR3 as a bright yellow solid (0.141 g, 60%).

### EXAMPLE 21

### Synthesis of [Ir(ppy)₂bpy][PF₆] IR5

[Ir(ppy)₂bpy][PF₆] IR5 is synthesized using the method of Example 20 with 2,2′-bipyridyl instead of its phenylbromide substituted derivative IR.

### EXAMPLE 22

### Synthesis of [Ir(ppy)2bpyPh₄bpyIr(ppy)₂][PF₆]₂ IR7

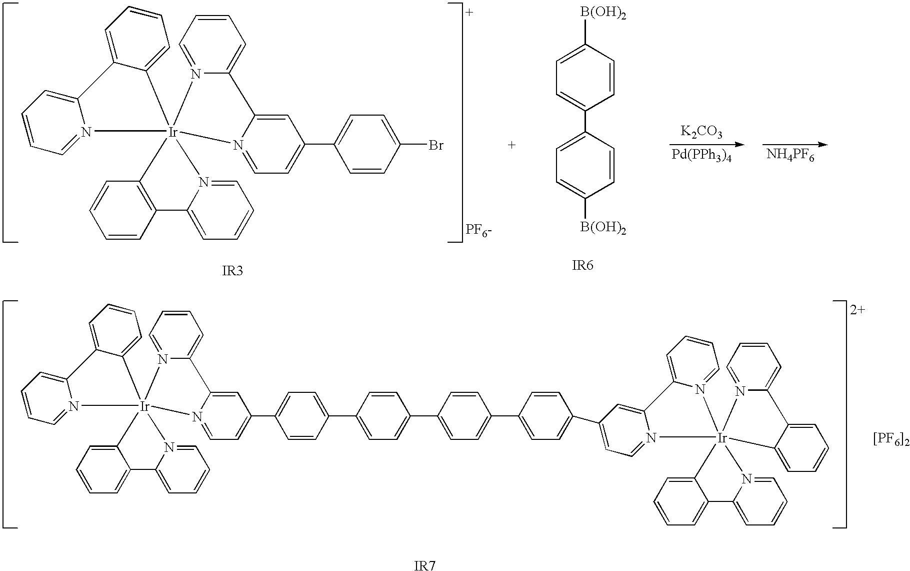

A mixture of the metal-ion complex IR3 (0.035 g, 0.036 mmol), K₂CO₃ (0.04 g, excess) and diboronic compound IR6 (0.004 g, 0.018 mmol) in anhydrous DMF (35 cm³) is degassed three times using the freeze, pump, thaw technique. Palladium tetrakistriphenylphosphine (0.4 mg, 0.00036 mmol) is then added. The mixture is heated to reflux under a nitrogen atmosphere for 18 hours. The DMF is removed under vacuum. The resulting solid is washed with water (3×30 cm³), methanol (30 cm³) and diethylether (30 cm³). The solid is dissolved in dichloromethane and applied to a silica column eluted with dichloromethane/methanol 95:5. The yellow fractions are combined and the solvent is removed in vacuo. The solid is then purified using preparative thin layer chromatography using MeCN(40): H2O(10): MeOH(10): NaCl(1) The slowest moving band is removed and the compound washed off using the eluent. The desired complex is precipitated with ammonium hexafluorophosphate to yield IR7 as a yellow/orange solid (0.017 g. 52%).

### EXAMPLE 23

### Not in Accordance with the Invention

### ITO/green-PPV+40 w % [Ir(ppy)₂bpy][PF₆] IR5/Au

A glass substrate covered with a 120 nm transparent ITO electrode layer is treated for 10 min with UV/O₃ (UVP PR-100) prior to further processing: On top of the ITO layer, an EL layer is deposited by means of spin-coating a dichloromethane solution containing 3 mg/ml green-emitting polymer poly(2-(m-3,7-dimethyioctyloxy-phenyl)-p-phenylene-vinylene (green-PPV) and a quantity of the Ir-complex [(ppy)₂bpy][PF₆] IR5. The amount of Ir-complex in the solution is selected such that the resulting EL layer comprises per 1 g of green-PPV and 0.4 g Ir-complex. The solution used for spin-coating is prepared by stirring at RT overnight a corresponding green-PPV/CH₂Cl₂ solution, then adding the Ir-complex, stirring the solution so obtained at RT for 1 hour and filtering over a 5 μm PTFE filter (Millex, Millipore). The EL layer has a thickness of 60-70 nm which is obtained by spinning at 1200 rpm (10 s), followed by 300 rpm (25 s). On top of the EL layer a 100 nm Au cathode electrode layer is deposited by vacuum evaporation at a rate of 0.25 nm/s.

The EL device thus obtained is conveniently represented as ITO/green-PPV+40 w % [Ir(ppy)₂bpy][PF₆] IR5/Au.

The EL device is stressed in forward (positive voltage on ITO electrode) and reverse bias. Current versus applied bias and photo-current versus applied bias curves are recorded. Both in reverse and forward bias current and photo-current is observed. The curves are nearly symmetrical around 0 V and the onset of current and photo-current is about (−)4 to (−)5 V. The spectrum of the light emitted in forward and reverse bias is essentially the same (λₘₐₓ, about 575 nm) and very similar to the photo-emission spectrum of [Ir(ppy)₂bpy][PF₆] IR5 dispersed in a polyvinylcarbazole matrix.

### EXAMPLE 24

### ITO/green-PPV+[Ir(ppy)₂bpyPh₄bpyIr(ppy)₂][PF₆]₂ IR7/Au

Example 23 is repeated with the difference that Ir-complex used is the bi-kernel complex [Ir(ppy)₂bpyPh₄bpyIr(ppy)₂][PF₆]₂ IR7 is used. The amount of IR7 is selected such that the number of Ir nuclei and PF₆ ions in the EL layer is the same as in Example 23.

The current versus applied bias and photo-current versus applied bias plots obtained by stressing the EL device in reverse bias and forward bias are nearly symmetrical around 0 V. Onset is about (−)4 to (−)5 V. Emission spectra in forward and reverse bias are recorded. In forward bias, light emission is predominantly from the metal complex (polymer: Ir-complex emission intensity=1:5). In reverse bias, light emission from the polymer is dominant (polymer: Ir-complex emission intensity=1.5:1). Thus, the EL device of the present example shows a two-color effect, be it less prominent than observed in corresponding Ru-complexes.

### EXAMPLE 25

### Not in Accordance with the Invention

### ITO/green-PPV+Ir(ppy)₂acac IR8/Au

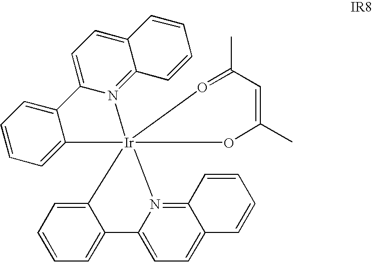

The EL device showed diode like behavior with no current in reverse bias. Light emission in forward bias is red/green originating the polymer and the Ir-complex.

1. An electroluminescent device including a first and a second electrode and an electroluminescent layer disposed therebetween, the electroluminescent layer comprising a first electroluminescent compound for emitting light of a first color, a second electroluminescent compound for emitting light of a second color which is distinct from the first color, and a conjugated compound comprising a distinct conjugated moiety which is distinct from any other conjugated moiety the first and the second electroluminescent compound comprises,
wherein the conjugated compound comprising the distinct conjugated moiety is the same as the second electroluminescent compound,
wherein the second electroluminescent compound is an ionic compound comprising ions adapted to be mobile within the electroluminescent layer when the electroluminescent is biased in the first and/or second direction to emit light of the first or second color respectively, wherein the second electroluminescent compound is a metal-ion complex comprising a metal and at least one ligand which is substituted with the distinct conjugated moiety, the distinct conjugated moiety being selected to cause the color of light emitted in the first direction to be distinct from the color of light emitted in the second direction.

2. A device as claimed in claim 1 wherein the first electroluminescent compound is an organic conjugated compound of low molecular weight or a conjugated polymer.

3. A device as claimed in claim 1 or 2 wherein the second electroluminescent compound is a metal-ion complex comprising a Ru, Rh, Re, Os, Zn, Cr, Pd, Pt, Ir, Cu, Al, Ga or a rare earth metal.

4. A device as claimed in claim 3 wherein the metal-ion complex comprises a metal-ion selected from the group of Ru(II), Rh(I), Re(I), Os(II), Zn(II), Al(III), Cr(III), Pt(II), Pt(IV) Pd(II), Ir(III), Cu(I), Ga(III) Ru(II), Ir(III) and Cr(III) and a rare earth metal ion.

5. A device as claimed in claim 1, 2, 3 or 4 wherein the ligand is selected in accordance with one of the following formula: 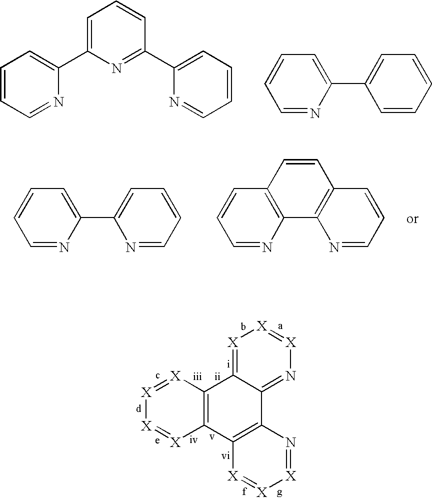
wherein X is independently CH or N, preferably at least one of the groups X being N, and the bonds a, b, c, d, e, f, and g, and the combination of bonds i/ii/iii and iv/v/vi are optionally condensed with a benzene group or a condensed aromatic moiety, wherein aromatic carbon atoms may be replaced by nitrogen, oxygen, phosphor or sulfur atoms and wherein a carbon atom of a ligand selected according to one of the above formula may be substituted with C₁₋₆ alkyl, C₂₋₆ alkenyl, C₂₋₆ alkynyl, C₃₋₄ alkylene, CN, halogen, COOH, C₁₋₃ alkyl-COOH, NO₂, NH₂.

6. A device as claimed in claim 1, 2, 3, 4 or 5 wherein the distinct conjugated moiety is a univalent, bivalent or multivalent radical of a π-conjugated compound or a σ-conjugated compound with enhanced through bond interaction selected from the group consisting of alkenes, alkynes, aromatic compounds, arylalkenes, thiophenes, vinylthiophenes, fluorenes, anilines, vinylcarbazoles, phenylenethynes and pyrroles or oligomers of conjugated compounds selected from said group, C₅-C₁₀₀ fused aromatic hydrocarbons in which an aromatic carbon atom may or may not replaced with a nitrogen, a phospor, sulfur or an oxygen atom, cyanines, squaryl or croconyl containing conjugated compounds, wherein each conjugated carbon atom of any such π-conjugated or σ-conjugated compound may or may not be substituted with a C₁-C₁₀₀ alkyl group, branched or unbranched, cyclic or acyclic, in which each non-neighboring carbon atom may be replaced with an oxygen, sulphur, nitrogen or phosphorus atom or substituted with a halogen, hydroxy, unsubstituted or alkyl substituted amino, nitrile, alkyl ether, branched or unbranched alkyl and/or alkenyl, nitro, trialkylphosphino, unsubstituted and substituted phenyl, carboxyl, carboxyl ester, carbamide or aryl, such as phenyl, group which aryl group is optionally substituted with an alkyl or an alkoxy group.

7. A device as claimed in claim 1, 2, 3, 4, 5 or 6 wherein the second electroluminescent compound is a metal-ion complex comprising a first and a second metal-ion and respective first and second ligand bonded thereto, where the first and second ligand, being substituted with the same distinct bivalent conjugated moiety, are joined to each other.

8. The electroluminescent device as claimed in claim 7, wherein the metal-ion is Ru(II) or Ir(III), the ligand or ligands being bonded is a 2,2′-bipyridyl or a phenylpyridine and the distinct bivalent conjugated moiety is an oligo-phenylene, an oligo-fluorene, such as an oligo-bifluorene or an oligo-9,9′-spirobifluorene, or an oligo-phenylenevinylene.

9. The electroluminescent device as claimed in any one of the preceding claims wherein the second electroluminescent material is: 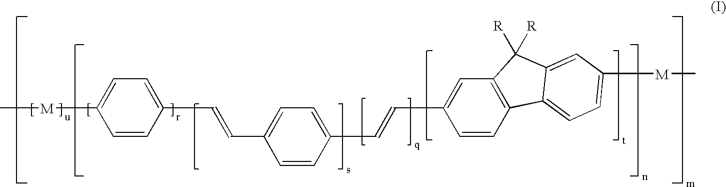
where 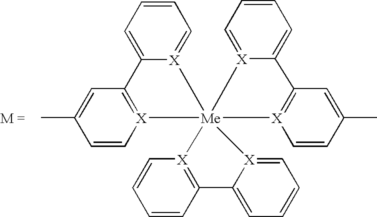
Me is Ru(II) or Ir(II), X═C or N. n=1-15, m=1-100, u=0or 1, q=0 or 1 and s=0-4, t=0-4, r=0-4 and R is, the same or different, H, C₁-C₂₀ alkyl or alkoxy or, substituted or unsubstituted C₄-C₂₀ aryl.

10. The electroluminescent device of claim 9 wherein n=3-6, m=1, r=1, s=0 and t=0, q=0, u=0 or 1.

11. The electroluminescent device of claim 9 wherein n=1-6, m=1, s=1, q=0 or 1, and t=0, r=0, u=0 or 1.

12. The electroluminescent device of claim 9 wherein n=3-6, m=1, s=0 and t=1, r=0, q=0, u=0 or 1.

13. The electroluminescent device as claimed in any one of the claims 1 to 8 wherein the second electroluminescent material is: 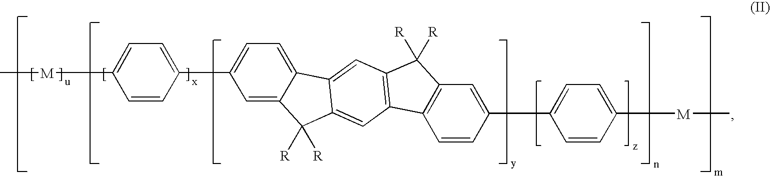
where 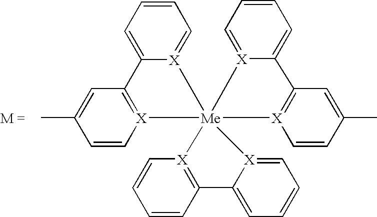
and Me is Ru(II) or Ir(III), X═C or N, n=1-15, m=1-100, u=0 or 1, x=0 or 1, z=0 or 1 and y=1-10 R is, the same or different, H, C₁-C₂₀ alkyl or alkoxy or, substituted or unsubstituted C₄-C₂₀ aryl.

14. The electroluminescent device of claim 13 wherein C or N, n=1, m=1, x=1, z=1 and y=1, u=0 or 1.

15. An electroluminescent device as claimed in any one of the preceding claims wherein the first and the second electroluminescent compound are one and the same compound.
